(19) United States
(12) Patent Application Publication
(10) Pub. No.: US 2022/0292057 A1
(43) Pub. Date: Sep. 15, 2022

(54) STORAGE DEVICE, STORAGE CLIENT DEVICE, AND CONTROL METHOD

(71) Applicant: Kioxia Corporation, Tokyo (JP)

(72) Inventor: Yoshihiro OHBA, Kawasaki Kanagawa (JP)

(21) Appl. No.: 17/472,447

(22) Filed: Sep. 10, 2021

(30) Foreign Application Priority Data
Mar. 9, 2021 (JP) 2021-037467

(51) Int. Cl. G06F 16/14; G06F 16/16; G06F 16/182

(52) U.S. Cl. CPC G06F 16/152; G06F 16/156; G06F 16/162; G06F 16/1824

(57) ABSTRACT

According to one embodiment, a storage device includes a storage and a controller. The storage stores a first table and a second table. The first table includes a set of a key and a value. The second table includes a set of the key and a member set that is a group of members requesting the value to be stored in the first table in association with the key. When receiving a delete command that requests the value associated with the key to be deleted in the first table, the controller deletes the member issuing the delete command in the member set stored in the second table, and deletes an entry corresponding to the key in the first table and an entry corresponding to the key in the second table when number of members in the member set becomes zero.

### CROSS-REFERENCE TO RELATED APPLICATIONS

This application is based upon and claims the benefit of priority from Japanese Patent Application No. 2021-037467, filed Mar. 9, 2021, the entire contents of which are incorporated herein by reference.

### FIELD

Embodiments described herein relate generally to a storage device, a storage client device, and a control method.

### BACKGROUND

A key value store (KVS) is a generic name of the data store maintaining a set of a search key and a value corresponding to the search key. In general, KVS is shared by a plurality of clients. In a conventional KVS, any client that is allowed to share KVS can freely issue a get command, a set command, and a delete command that are operation commands of the KVS.

One of the representative applications of the KVS is a Blockchain system. In the Blockchain system, each Blockchain node (hereinafter referred to as a node) participating in a peer-to-peer (P2P) network repeats a series of procedures of (1) broadcasting a transaction generated by the client, (2) executing the received transaction, (3) generating and broadcasting a block that is an execution history of the executed transaction, and (4) when receiving the block, distributing and executing an agreement formation algorithm for the received block, at each node, and adding the block that is successful in agreement formation to the own Blockchain. At this time, the blocks of the same contents are held in each node.

That is, in the P2P network in which N nodes participate, N copies per block exist in the distributed storages on the P2P network.

When an NVMe-oF-ready storage server is used as the distributed storages on the P2P network, it is expected that the storage capacity can be suppressed to 1/N by sharing and holding entities of the blocks by N nodes instead of holding copies of N blocks in the storage server.

### BRIEF DESCRIPTION OF THE DRAWINGS

FIG. 1 is a block diagram illustrating an example of a hardware configuration of a computer to which a shared controlled type KVS of a first embodiment is applied.

FIG. 2 is a functional block diagram illustrating the shared controlled type KVS of the first embodiment.

FIG. 3 is a flowchart illustrating a set command of the shared controlled type KVS of the first embodiment.

FIG. 4 is a flowchart illustrating a get command of the shared controlled type KVS of the first embodiment.

FIG. 5 is a flowchart illustrating a delete command of the shared controlled type KVS of the first embodiment.

FIG. 6 is a block diagram illustrating an example of a hardware configuration of a network storage device to which the shared controlled type KVS of the first embodiment is applied.

FIG. 7 is a block diagram illustrating an example of a hardware configuration of a network storage device to which a shared controlled type KVS of a second embodiment is applied.

FIG. 8 is a functional block diagram illustrating the shared controlled type KVS of the second embodiment.

FIG. 9 is a flowchart illustrating a set command of the shared controlled type KVS of the second embodiment.

FIG. 10 is a flowchart illustrating a get command of the shared controlled type KVS of the second embodiment.

FIG. 11 is a flowchart illustrating a delete command of the shared controlled type KVS of the second embodiment.

FIG. 12 is a functional block diagram illustrating a shared controlled type KVS in a case of not using a distributed lock unit of a third embodiment.

FIG. 13 is a functional block diagram illustrating a shared controlled type KVS in a case of using the distributed lock unit of the third embodiment.

FIG. 14 is a flowchart illustrating a KVS operation command of the shared controlled type KVS in a case of not using the distributed lock unit of the third embodiment.

FIG. 15 is a flowchart illustrating the KVS operation command of the shared controlled type KVS in a case of using the distributed lock unit of the third embodiment.

FIG. 16 is a block diagram illustrating an example of a configuration of a member set KV and data KV in a shared controlled type KVS of a fourth embodiment.

### DETAILED DESCRIPTION

Embodiments will be described hereinafter with reference to the accompanying drawings.

In general, according to one embodiment, a storage device includes a storage and a controller. The controller is configured to control input and output of the storage. The storage is configured to store a first table and a second table. The first table includes a set of a search key and a value. The second table includes a set of the search key and a member set that is a group of members issuing a set command to request the value to be stored in the first table in association with the search key. The controller is configured to: when receiving the set command including a first search key and a first value in a parameter, and when the value stored in the entry of the first table corresponding to the first search key matches the first value, add the member issuing the set command to the member set stored in the entry of the second table corresponding to the first search key; when receiving a get command that requests the value associated with the search key to be acquired from the first table, the search key being included as a second search key in a parameter, and when the member issuing the get command is included in the member set stored in the entry of the second table corresponding to the second search key, output the value stored in the entry of the first table corresponding to the second search key, from the first table; and when receiving a delete command that requests the value associated with the search key to be deleted in the first table and that includes a third search key in a parameter, delete the member issuing the delete command in the member set stored in the entry of the second table corresponding to the third search key, and delete the entry corresponding to the third search key in the first table and the entry corresponding to the third search key in the second table when number of members included in the member set becomes zero.

### First Embodiment

First, a first embodiment will be described.

As described above, when an NVMe-oF-ready storage server is used as the distributed storages on the P2P network, it is expected that the storage capacity can be suppressed to 1/N by sharing and holding an entity of the block by N nodes instead of holding copies of N blocks in the storage server. However, when the entity of the block is shared by a plurality of nodes using the conventional KVS, the following two problems occur.

The first problem is that when the entity of the block received by a certain node is held by the KVS, the other node has not received this block but can access this block.

The second problem is that when a block is deleted by a certain node, the other node still holds this block but cannot access this block after the deletion.

Both the first problem and the second problem cause the malfunction of the Blockchain system.

The first embodiment relates to a shared controlled type KVS wherein when data held by the KVS is shared by a plurality of nodes, an influence of the data operation executed by the other node that can be executed separately from the data operation executed by the own node can be eliminated for each of the plurality of nodes.

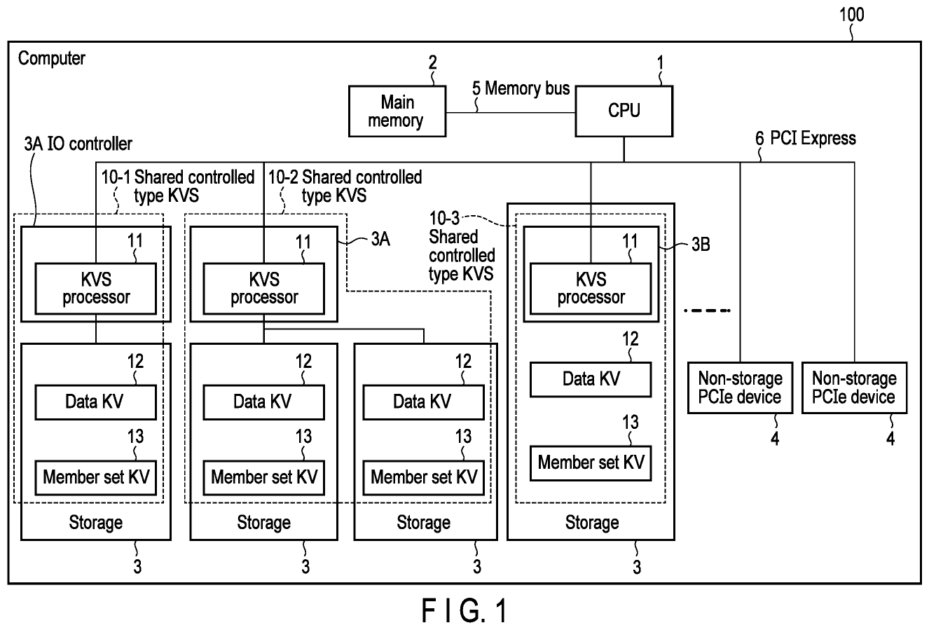

FIG. 1 is a block diagram illustrating an example of a hardware configuration of a computer 100 to which a shared controlled type KVS 10 of the first embodiment is applied. Incidentally, FIG. 1 illustrates three implementation examples of the shared controlled type KVS (10-1 to 3).

A computer 100 is a server, a personal computer, or the like. The computer 100 includes a CPU 1, a main memory 2, a plurality of storages 3, and a plurality of non-storage PCI Express (PCIe)™ devices 4. In addition, the computer 100 includes a memory bus 5 and a PCIe bus 6. An IO controller 3A for controlling input and output of the storage 3 is provided externally or an IO controller 3B for controlling input and output of the storage 3 is provided internally to each of the plurality of storages 3.

The CPU 1 is connected to the main memory 2 by the memory bus 5. In addition, the CPU 1 is connected to the plurality of storage 3 and the plurality of non-storage PCIe devices 4 by the PCIe bus 6. The CPU 1 executes programs in the main memory 2 connected by the memory bus 5. The CPU 1 controls the plurality of storages 3 and the plurality of non-storage PCIe devices 4 connected by the PCIe bus 6 according to descriptions of the programs.

The shared controlled type KVS 10 of the first embodiment is configured by a KVS processor 11, data KV12, and a member set KV13. The KVS processor 11 may be built in, for example, the IO controller 3A or the IO controller 3B. The KVS processor 11 may be implemented by hardware such as an electric circuit or may be implemented by a program (software) run by a processor (not illustrated). The data KV 12 and the member set KV are stored in the storages 3.

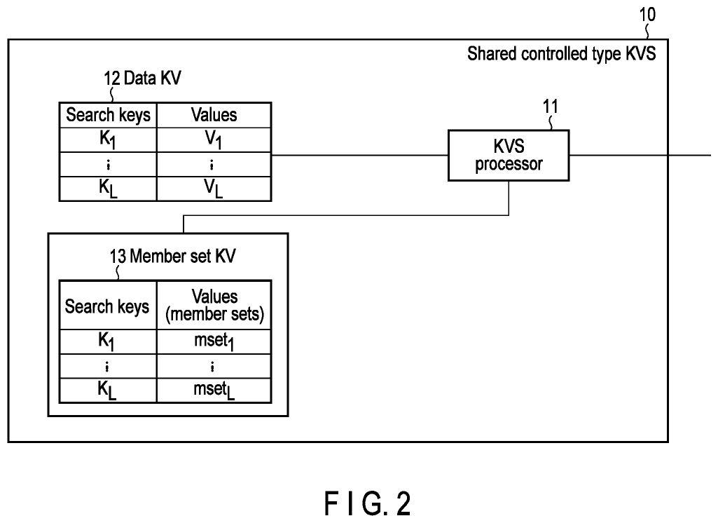

As described above, FIG. 1 illustrates three implementation examples of the shared controlled type KVS 10 (10-1 to 3). In the shared controlled type KVS 10-1, the KVS processor 11 is attached externally to the storage 3. This KVS processor 11 may be implemented in the external IO controller 3A as illustrated in, for example, FIG. 1. In the shared controlled type KVS 10-2, the plurality of storages 3 are connected to one KVS processor 11. It is assumed here that, for example, functions of the KVS processor 11 are built in a portion such as a RAID controller or the functions of the KVS processor 11 are built in a bridge chip such as a PCIe switch together with a function of processing the storage protocol. This KVS processor 11 may be implemented in the external IO controller 3A as illustrated in, for example, FIG. 1. In the shared controlled type KVS 10-3, the KVS processor 11 is integrated in the storage 3. This KVS processor 11 may be implemented in the IO controller 3B in the storage 3 as illustrated in, for example, FIG. 1. Incidentally, the essential functions of the KVS processor are not limited depending on external or internal attachment to the storage 3. FIG. 2 is a functional block diagram illustrating the shared controlled type KVS 10 of the first embodiment that can be thus implemented in various aspects.

As described above, the shared controlled type KVS 10 is configured by the KVS processor 11, the data KV 12, and the member set KV 13.

While, for example, receiving the KVS control command from the outside such as CPU 1, and the like illustrated in the FIG. 1, and, referring to and updating the member set KV 13 in accordance with contents of the KVS operation commands, the KVS processor 11 executes an operation corresponding to a predetermined KV entry of the data KV 12 and outputs the execution result of the KVS operation command to the outside. The KVS operation command is, for example, the get command, the get command, or the delete command.

The set command is a command to request a value to be stored in the data KV 12 in association with a search key. The get command is a command to request the value associated with a search key to be acquired from the data KV 12. The delete command is a command to request the value associated with a search key to be deleted in the data KV 12.

The data KV 12 is a table (first table) storing sets of the search keys and the values, which are associated by the set command. The data KV 12 of FIG. 2 include L entries, and the value for search key Kᵢ (i=1, . . . , L) is represented as Vᵢ.

The member set KV 13 is a table (second table) storing sets of the search keys and the member sets for the respective search keys stored in the data KV 12. The member set is a group of members specifying the same search key and value and issuing the set command. The member set KV 13 of FIG. 2 includes L entries, and the member set for search key Kᵢ (i=1, . . . , L) is represented as msetᵢ.

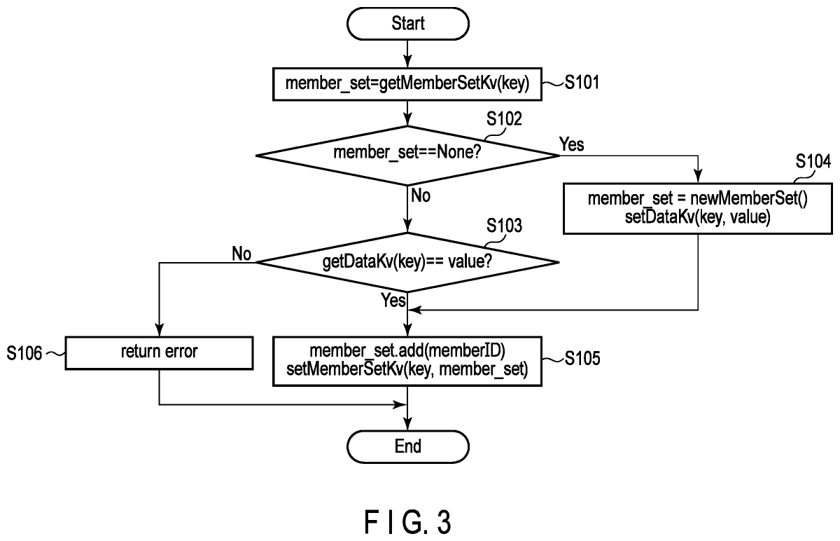

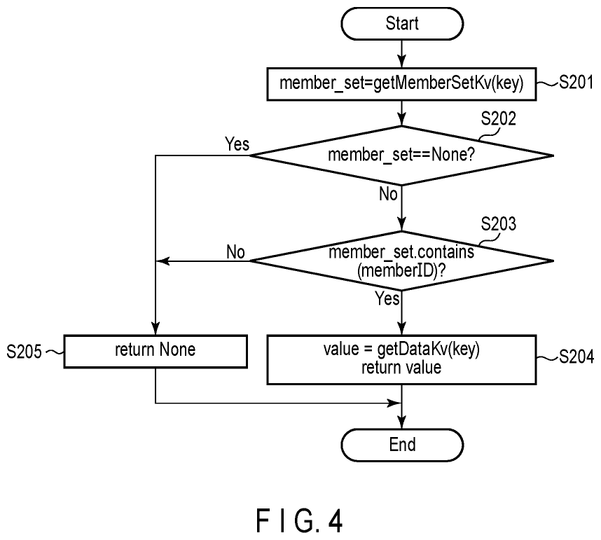

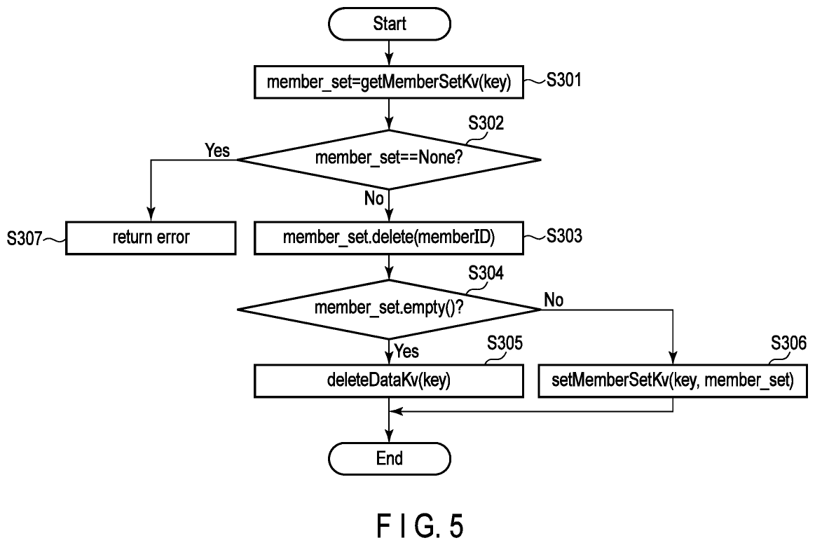

Next, the operations of the KVS operation commands of the shared controlled type KVS 10 in the first embodiment illustrated in FIG. 2 will be described with reference to FIG. 3, FIG. 4, and FIG. 5. It is assumed in the following descriptions that a structure (referred to as a context) for maintaining an attribute and a condition of each member necessary to execute the KVS operation commands is assigned to the member of the KVS operation command source and that the KVS operation commands are called while accompanying the context of the call source member. It is also assumed that a member identifier is included in the attribute of the context. In the following descriptions, input and output of the information will be explained in general-purpose expressions without specifying the relationship in connection with the host and the relationship in connection with the nonvolatile memory but, actually, commands based on various protocols can be used.

FIG. 3 is a flowchart illustrating a set command of the shared controlled type KVS 10 of the first embodiment.

The KVS processor 11 receives the set command issued by a member (for example, an application program on the node) from the outside, and the present operation is thereby started. The set command includes the search key (key) and the value in an input argument (parameter). A member identifier of the set command call source context is referred to as a member ID.

The KVS processor 11 first acquires a member set (member_set) corresponding to the key from the member set KV 13 in getMemberSetKv(key) (S101). getMemberSetKv is a command having the key in the input argument and is a command to request the member set corresponding to the key to be acquired from the member set KV 13. If the member set does not exist (S102: Yes), the KVS processor 11 generates a new member set by newMemberSet( ), sets this as member set, and sets the value to the value of the entry corresponding to the key of the data KV12 by setDataKv(key, value) (S104). The case where the member set does not exist is a case where the set command including the target key in the input argument is first received. newMemberSet( ) is a command to request the member set KV 13 to generate a new member set. setDataKv is a command including the key and the value in the input argument and a command to request the value to be set as the value of the entry corresponding to the key of the data KV 12.

Next, the KVS processor 11 adds a member corresponding to the memberID to member_set by member_set.add(memberID), and sets member_set to the member set of the entry corresponding to the key of the member set KV 13 by setMemberSetKv(key, member_set) successively (S105). member_set.add is a command including the member identifier (memberID) in the input argument and is a command to request the member corresponding to memberID to be added to member_set. setMemberSetKv is a command including the key and the member set (member_set) in the input argument and is a command to request member_set to be set to the member set of the entry corresponding to the key of member set KV 13. When ending step S105, the KVS processor 11 ends the process on the set command.

In contrast, if the member set exists (S102: No), the KVS processor 11 retrieves the data KV 12 by getDataKv(key) (S103). The case where the member set exists is a case where the set command including the target key in the input argument has been previously received. getDataKv is a command including the key in the input argument and is a command to request the value corresponding to the key to be acquired from the data KV 12. If the value of the entry corresponding to key of the data KV 12 matches the value (S103: Yes), the KVS processor 11 adds the member corresponding to memberID to member_set by member_set.add(memberID), and sets member_set to the member set of the entry corresponding to the key of the member set KV 13 by setMemberSetKv(key, member_set) (S105). When ending step S105, the KVS processor 11 ends the process on the set command.

If the value of the entry corresponding to the key of the data KV 12 does not match the value (S103: No), the KVS processor 11 outputs an error (S106) and ends the process on the set command.

FIG. 4 is a flowchart illustrating a get command of the shared controlled type KVS 10 of the first embodiment.

The KVS processor 11 receives the get command issued by the member from the outside, and the present operation is thereby started. The get command includes the key in the input argument. A member identifier of the get command call source context is referred to as memberID.

The KVS processor 11 first acquires the member set (member_set) of the entry corresponding to the key from the member set KV 13 by getMemberSetKv(key) (S201). If an entry corresponding to the key does not exist (S202: Yes), the KVS processor 11 outputs no value (None) (S205). The case where the entry corresponding to the key does not exist is a case where the set command including the target key in the input argument is not received. When ending step S205, the KVS processor 11 ends the process on the get command.

In contrast, if the entry corresponding to key exists (S202: No), the KVS processor 11 checks whether the member corresponding to memberID is included in member_set or not by member_set.contains(memberID) (S203). member_set.contains is a command including the member identifier (memberID) in the input argument and is a command to request checking whether the member corresponding to memberID is included in member_set or not. If the member corresponding to memberID is included in member_set (S203: Yes), the KVS processor 11 acquires the value corresponding to the key from the data KV 12 and outputs this value by getDataKv(key) (S204). The case where the member corresponding to memberID is included in memberID is a case where the member corresponding to memberID issues the set command including the target key in the input argument. When ending step S204, the KVS processor 11 ends the process on the get command.

If the member corresponding to memberID is not included in member_set (S203: No), the KVS processor 11 outputs no value (None) (S205). The case where the member corresponding to memberID is not included in memberID is a case where the member corresponding to memberID does not issue the set command including the target key in the input argument. That is, the value of data KV 12 can be acquired only by the member who has issued the set command on the value. When ending step S205, the KVS processor 11 ends the process on the get command.

FIG. 5 is a flowchart illustrating the delete command of the shared controlled type KVS 10 of the first embodiment.

The KVS processor 11 receives the delete command issued by the member from the outside, and the present operation is thereby started. The delete command includes the key in the input argument. A member identifier of the delete command call source context is referred to as a member ID.

The KVS processor 11 first acquires the member set (member_set) of the entry corresponding to the key from the member set KV 13 by getMemberSetKv(key) (S301). If the entry corresponding to the key does not exist (S302: Yes), the KVS processor 11 outputs an error (S307) and ends the process on the delete command.

In contrast, if the entry corresponding to key exists (S302: No), the KVS processor 11 deletes the member corresponding to memberID in member_set by member_set.contains(memberID) (S303). member_set.delete is a command including the member identifier (memberID) in the input argument and is a command to request the member corresponding to memberID to be deleted in member_set. If member_set is empty (S304: YES), the KVS processor 11 deletes the entry corresponding to the key in the data KV 12 by deleteDataKv(key) (S305). The case where the member_set is empty is a case where all the members having issued the set command including the target key in the input argument issue the delete command including the key in the input argument. deleteDataKv is a command including the key in the input argument and is a command to request the entry corresponding to the key to be deleted in the data KV 12. That is, the value of data KV 12 is deleted only when all the members having issued the set command on the value issue the delete command. When ending step S305, the KVS processor 11 ends the process on the delete command.

If member_set is not empty (S304: No), the KVS processor 11 sets member_set at the member set of the entry corresponding to the key of the member set KV 13 by setMemberSetKv(key, member_set) (S306). This member_set is member_set by which the member corresponding to memberID is deleted in step S303. When ending step S306, the KVS processor 11 ends the process on the delete command.

Described above are the operations of the shared controlled type KVS 10 according to the first embodiment. Thus, the first embodiment has an advantage of preventing an operation error of the KVS use application, which results from a situation that a certain member of the members sharing the same KVS makes a mistake of executing the get command or delete command for the KV entry for which the member does not issue the set command by himself.

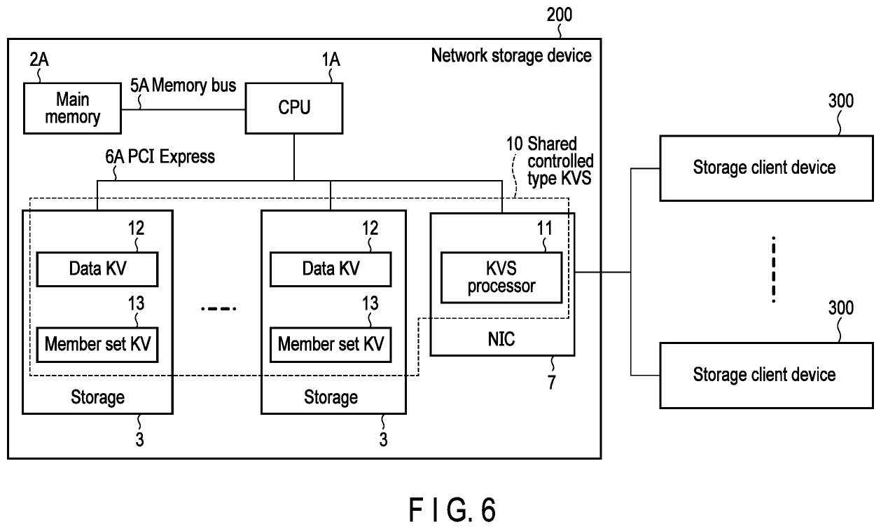

Incidentally, FIG. 1 illustrates the example of applying the shared controlled type KVS 10 of the first embodiment to the computer 100. The KVS operation command is not limited to that generated by the software which runs on the CPU 1 illustrated in FIG. 1, for example. For example, the KVS operation may be generated by software executed on the other computer connected through a network. FIG. 6 is a block diagram illustrating an example of a hardware configuration of a network storage device 200 to which the shared controlled type KVS 10 of the first embodiment is applied. FIG. 6 illustrates an example that the KVS processor 11 is attached to the system in a form of accompanying the network storage device 200.

The network storage device 200 includes a network interface unit (network interface card [NIC]) 7. The network interface unit 7 controls the communication through the network with a storage client device 300. In FIG. 6, the KVS processor 11 is integrated with the network interface unit 7.

An arbitrary network may be used other than a network using the TCP/IP, as the network. The KVS operation command is issued by the storage client device 300. In addition, it has been described in FIG. 6 that the network storage device 200 is a server installed outside physically, but may be a logically divided computer (virtual computing machines or the like).

The network storage device 200 illustrated in FIG. 6 can prevent an operation error of the KVS use application, which results from a situation that a certain member of the members sharing the same KVS makes a mistake of executing the get command or delete command for the KV entry for which the member does not issue the set command by himself.

As described above, the shared controlled type KVS 10 of the first embodiment can eliminate the influence of the data operation of the other nodes that can be executed separately from the data operation of the own node, in each of a plurality of nodes, when the data (search keys and values of the data KV 12) are shared by a plurality of nodes.

### Second Embodiment

Next, a second embodiment will be described. The second embodiment relates to a shared controlled type KVS where a plurality of KVS processors 11 are distributed in the network. Particularly, the present embodiment is an effective embodiment when accessing a storage of KVS through a network by using NVMe-oF, a network file system or the like.

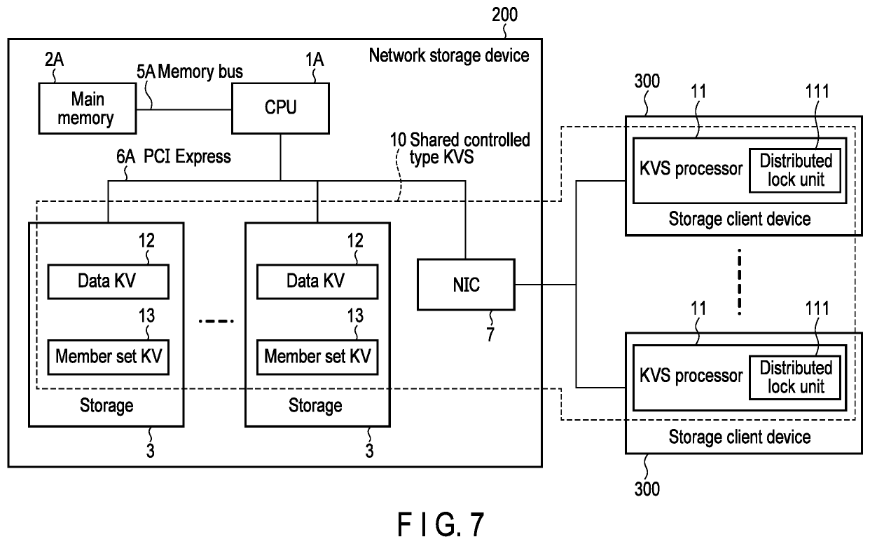

FIG. 7 is a block diagram illustrating an example of a hardware configuration of a network storage device 200 to which a shared controlled type KVS 10 of a second embodiment is applied. In the first embodiment, the example that the KVS processor 11 is integrated with the network interface part 7 has been described (cf. FIG. 6). An example that the KVS processor 11 including a distributed lock unit 111 to be described later is integrated in a storage client device 300 will be described here. In the second embodiment, too, the KVS processor 11 may be implemented by hardware such as an electric circuit or may be implemented by a program (software) run by a processor (not illustrated). The data KV 12 and the member set KV are stored in the storages 3.

Incidentally, in FIG. 7, the network storage device 200 is a server installed outside physically, but may be a logically divided computer (virtual computing machine or the like), similarly to the first embodiment. In the configuration illustrated in FIG. 7, a communication function is necessary for the KVS processor 11. More specifically, the function is a function of executing the KVS control command via a network and includes a network interface unit for physically connecting to the network and a protocol processor for processing a communication protocol such as TCP/IP and a storage protocol such as iSCSI or NVMe-oF. A command of accessing the data KV12 and the member set KV 13 may be input and output by the KVS processor 11 via them.

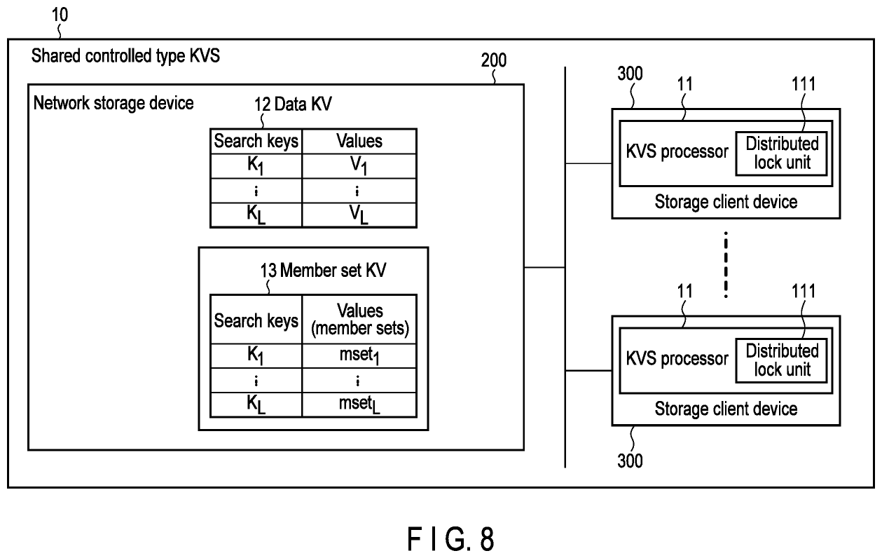

FIG. 8 is a functional block diagram illustrating the shared controlled type KVS 10 of the second embodiment.

The shared controlled type KVS 10 of the second embodiment is configured by the KVS processor 11 on each of one or more of storage client devices 300, the data KV 12 and the member set KV 13 on the network storage device 200.

Each KVS processor 11 includes a distributed lock unit 111. The distributed lock unit 111 is used to execute exclusive control of the KVS operation command between a plurality of KVS processors 11. One of examples of the distributed lock unit 111 is a distributed lock mechanism of ZooKeeper that is a distributed application aid tool. The configuration of each KVS processor 11 except the distributed lock unit 111 is the same as the KVS processor 11 of the first embodiment. In addition, the configurations of the data KV 12 and the member set KV 13 are the same as those described in the first embodiment. The distributed lock unit 111 may be implemented by hardware such as an electric circuit or may be implemented by a program (software) run by a processor (not illustrated).

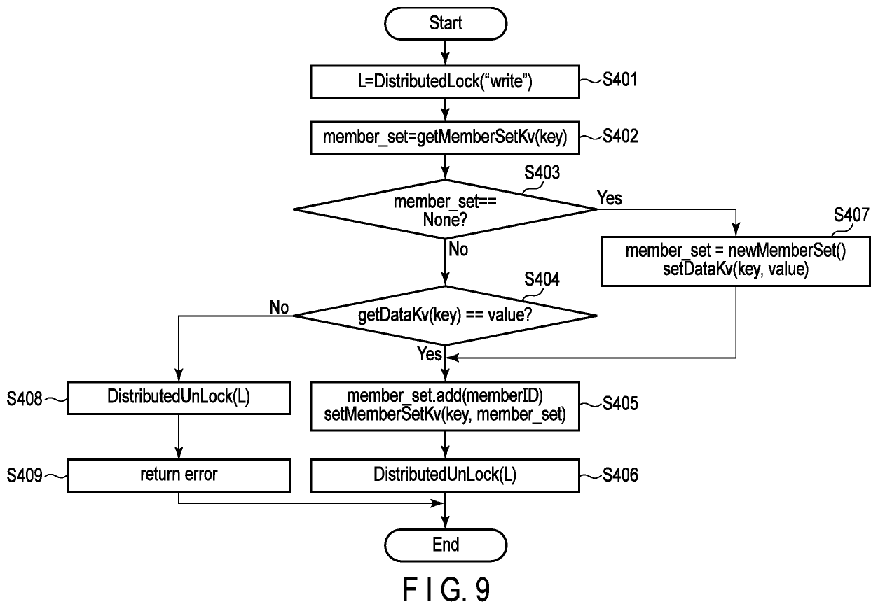

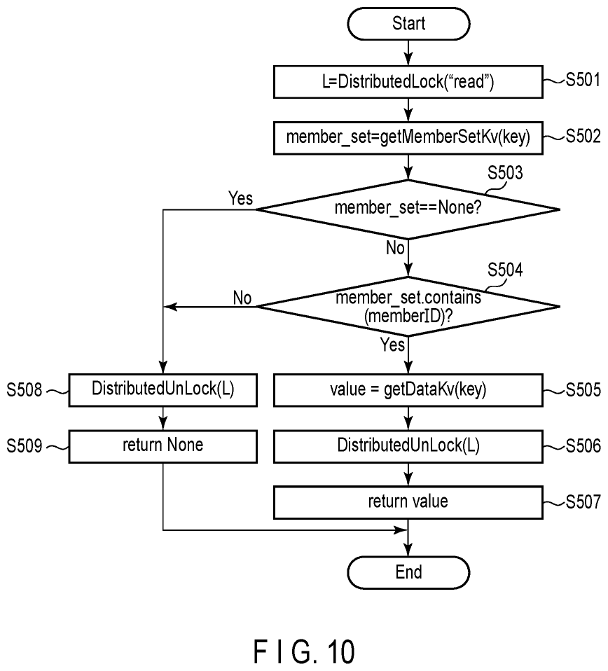

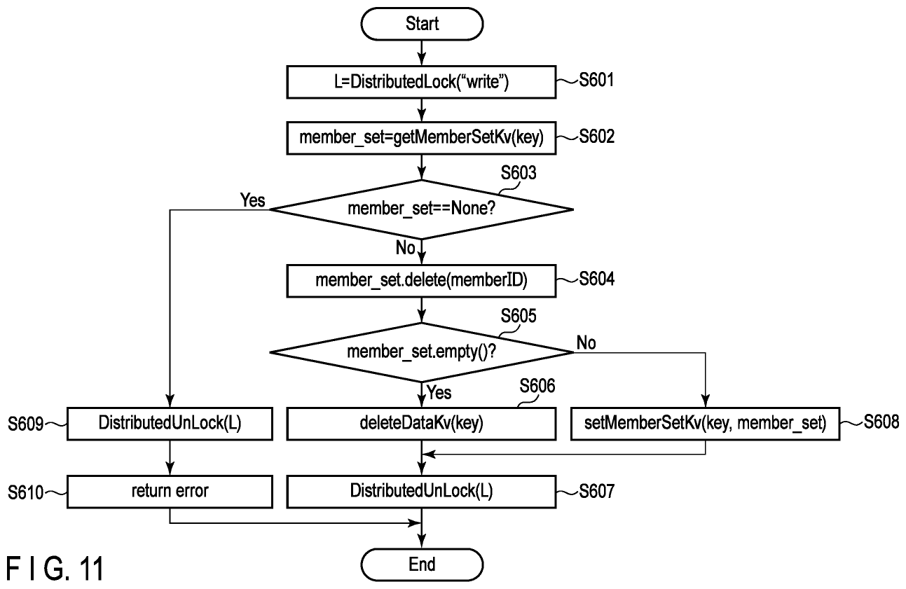

Next, the operations of the KVS operation commands of the shared controlled type KVS 10 in the second embodiment illustrated in FIG. 8 will be described with reference to FIG. 9, FIG. 10, and FIG. 11. It is assumed in the following descriptions that a structure (referred to as a context) for maintaining an attribute and a condition of each member necessary to execute the KVS operation commands is assigned to the member of the KVS operation command source and that the KVS operation commands are called while accompanying the context of the call source member. It is also assumed that a member identifier is included in the attribute of the context. In the following descriptions, input and output of the information will be explained in general-purpose expressions without specifying the relationship in connection with the host and the relationship in connection with the nonvolatile memory but, actually, commands based on various protocols can be used.

FIG. 9 is a flowchart illustrating a set command of the shared controlled type KVS 10 of the second embodiment.

The KVS processor 11 receives the set command issued by the member from the outside, and the present operation is thereby started. The set command includes the key and the value in the input argument. A member identifier of the set command call source context is referred to as a memberID.

The KVS processor 11 first awaits until the distributed lock for writing is acquired by L=DistributedLock (“write”) (S401). DistributedLock is a command to request the distributed lock to be acquired. Next, the KVS processor 11 acquires the member set (member_set) of the entry corresponding to the key from the member set KV 13 by getMemberSetKv(key) (S402). If the entry corresponding to the key does not exist (S403: Yes), the KVS processor 11 generates a new member set by newMemberSet( ), sets this as member_set, and sets the value to the value of the entry corresponding to the key of the data KV12 by setDataKv(key, value) (S407). In addition, the KVS processor 11 adds a member corresponding to the memberID to member_set by member_set.add(memberID), and sets member_set to the member set of the entry corresponding to the key of the member set KV 13 by setMemberSetKv(key, member_set) successively (S405). Then, the KVS processor 11 frees the distributed lock by DistributedUnLock(L) (S406) and ends the process on the set command. DistributedUnLock is a command to request the distributed lock acquired by DistributedLock to be freed.

In contrast, if the entry corresponding to the key exists (S403: No), the KVS processor 11 retrieves the data KV 12 by getDataKv(key) (S404). If the value of the entry corresponding to the key of the data KV 12 matches the value (S404: Yes), the KVS processor 11 adds the member corresponding to the member identifier to member_set by member_set.add(memberID), and sets member_set to the member set of the entry corresponding to the key of the member set KV 13 by setMemberSetKv(key, member_set) (S405). Then, the KVS processor 11 frees the distributed lock by DistributedUnLock(L) (S406) and ends the process on the set command.

If the value of the entry corresponding to the key of the data KV 12 does not match the value (S404: No), the KVS processor 11 frees the distribute lock by DistributedUnLock(L) (S408), outputs an error (S409) and ends the process on the set command.

FIG. 10 is a flowchart illustrating a get command of the shared controlled type KVS 10 of the second embodiment.

The KVS processor 11 receives the get command issued by the member from the outside, and the present operation is thereby started. The get command includes the key in the input argument. A member identifier of the get command call source context is referred to as memberID.

The KVS processor 11 awaits until the distributed lock for reading is acquired by L=DistributedLock(“read”) (S501). Next, the KVS processor 11 acquires the member set (member_set) of the entry corresponding to the key from the member set KV 13 by getMemberSetKv(key) (S502). If the member set does not exist (S503: Yes), the KVS processor 11 frees the distributed lock by DstributedUnLock(L) (S508), outputs no value (None) (S509) and ends the process on the get command.

In contrast, if the entry corresponding to key exists (S503: No), the KVS processor 11 checks whether the member corresponding to the member identifier is included in member_set or not by member_set.contains(memberID) (S504). If the member is included in member_set (S504: Yes), the KVS processor 11 acquires the value corresponding to the key from the data KV 12 by getDataKv(key) (S505). The KVS processor 11 frees the distributed lock by DistributedUnLock(L) (S506), outputs the value (S507), and ends the process on the get command.

If the member is not included in member_set (S504: No), the KVS processor 11 frees the distributed lock by DistributedUnLock(L) (S508), outputs no value (None) (S509) and ends the process on the get command.

FIG. 11 is a flowchart illustrating a delete command of the shared controlled type KVS 10 of the second embodiment.

The KVS processor 11 receives the delete command issued by the member from the outside, and the present operation is thereby started. The delete command includes the key in the input argument. A member identifier of the delete command call source context is referred to as a member ID.

The KVS processor 11 awaits until the distributed lock for writing is acquired by L=DistributedLock(“write”) (S601). Next, the KVS processor 11 acquires the member set (member_set) of the entry corresponding to the key from the member set KV 13 by getMemberSetKv(key) (S602). If the entry corresponding to the key does not exist (S603: Yes), the KVS processor 11 frees the distributed lock by DistributedUnLock(L) (S609), outputs an error (S610) and ends the process on the delete command.

In contrast, if the entry corresponding to key exists (S603: No), the KVS processor 11 deletes the member corresponding to memberID in member_set by member_set.delete(memberID) (S604). If member_set is empty (S605: No), the KVS processor 11 deletes the entry corresponding to the key in the data KV 12 by deleteDataKv(key) (S606), frees the distributed lock by DistributedUnLock(L) (S607), and ends the process on the delete command.

If member_set is not empty (S605: No), the KVS processor 11 sets member_set at the member set of the entry corresponding to the key of the member set KV 13 by setMemberSetKv(key, member_set) (S608), frees the distributed lock by DistributedUnLock(L) (S607), and ends the process on the delete command.

Described above are the operations of the shared controlled type KVS 10 according to the second embodiment. Thus, the same advantages as those of the first embodiment are achieved when a plurality of KVS processors 11 are distributed in the network. That is, the second embodiment has an advantage of preventing an operation error of the KVS use application, which results from a situation that a certain member of the members sharing the same KVS makes a mistake of executing the get command or delete command for the KV entry for which the member does not issue the set command by himself.

### Third Embodiment

Next, a third embodiment will be described. The third embodiment relates to shared controlled type KVS having KVS including a security verification function of a KVS operation command and a KVS management command. Particularly, the present embodiment is an effective embodiment when a large number of unspecified external entities including an attacker may issue the KVS control command and the KVS management command. The KVS management command is, for example, a register command, a deregister command or the like. The shared controlled type KVS of the third embodiment is applied to, for example, a network storage device. The configuration of the network storage device is similar to that of the second embodiment (cf. FIG. 7) and its descriptions will be omitted here.

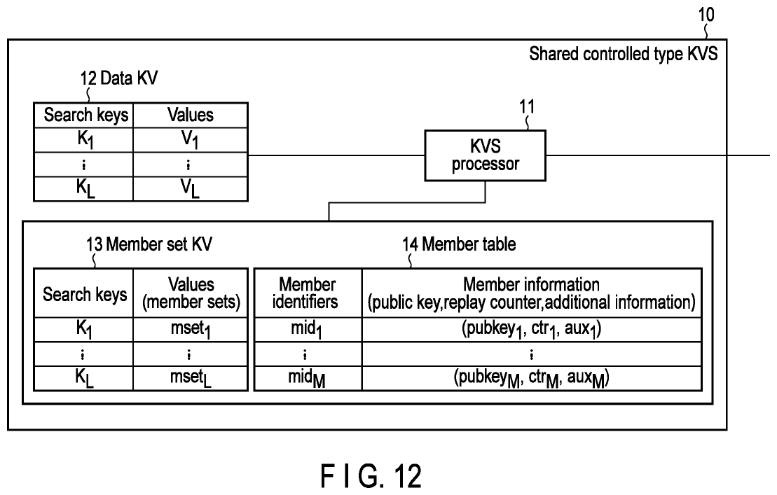

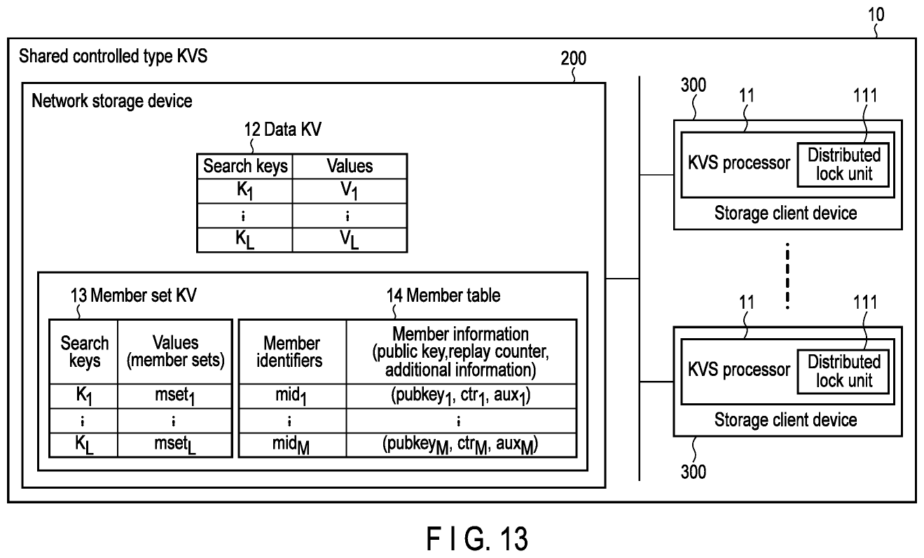

FIG. 12 illustrates a functional block diagram of a shared controlled type KVS 10 in a case of not using a distributed lock unit 111 (described in the second embodiment) of the third embodiment. In addition, FIG. 13 illustrates a functional block diagram of the shared controlled type KVS 10 in a case of using the distributed lock unit 111 of the third embodiment. Since the configurations of the shared controlled type KVS 10 of FIG. 12 and FIG. 13 are obtained by adding a member table 14 to the configurations of the shared controlled type KVS 10 of FIG. 2 (first embodiment) and FIG. 8 (second embodiment), respectively, only configuration of the member table 14 will be described.

The member table 14 is a table storing a set of a member identifier and member information for each member that can issue the KVS operation command.

The member identifier is a unique value in the shared controlled type KVS 10. For example, the ID of the Blockchain node may be used as the member identifier.

The member information of the member table 14 includes a public key, a replay counter and additional information.

The public key is a public key used to verify a digital signature assigned to the KVS operation command or the KVS management command issued by the member. The public key is assumed to be included in a digital certificate issued by a trusted certificate authority.

The replay counter is a counter for prevention of replay attack that is assigned to the KVS operation command or the KVS management command issued by the member. A value of the replay counter is incremented by 1 when the KVS operation command or the KVS management command is verified definitely. An initial value of the replay counter is 0.

The additional information is any information on the member. An example of use of the additional information will be described later.

The member table 14 has M entries, and the member information for the member identifier midᵢ (i=1, . . . , M) are referred to as (pubkeyᵢ, ctrᵢ, auxᵢ). pubkeyᵢ refers to the public key, ctrᵢ refers to the replay counter, and auxᵢ refers to the additional information.

The KVS processor 11 may receive the KVS management command from the outside and update the member table 14. The third embodiment defines a register command and a deregister command as the KVS management commands.

The register command is a command used for entry generation of the member table 14. The register command includes the member identifier (memberID), the digital certificate (cert) including the public key (pubkey) of the member, the replay counter (ctr), and the digital signature (sig) in the input argument, and includes additional information (aux) in the input argument as an optional argument.

The deregister command is a command used for entry deletion of the member table 14. The deregister command includes the member identifier (memberID), the replay counter (ctr), and the digital signature (sig) in the input argument.

In addition, the KVS operation command in the third embodiment includes the replay counter value (ctr) and the digital signature (sig) in the input argument, in addition to the input argument of the KVS operation command in the first embodiment and the second embodiment. A value of the signature calculated using the private key of the member to the byte sequence that input argument coupled byte strings of all input arguments except sig with a designated order enters the digital signature (sig).

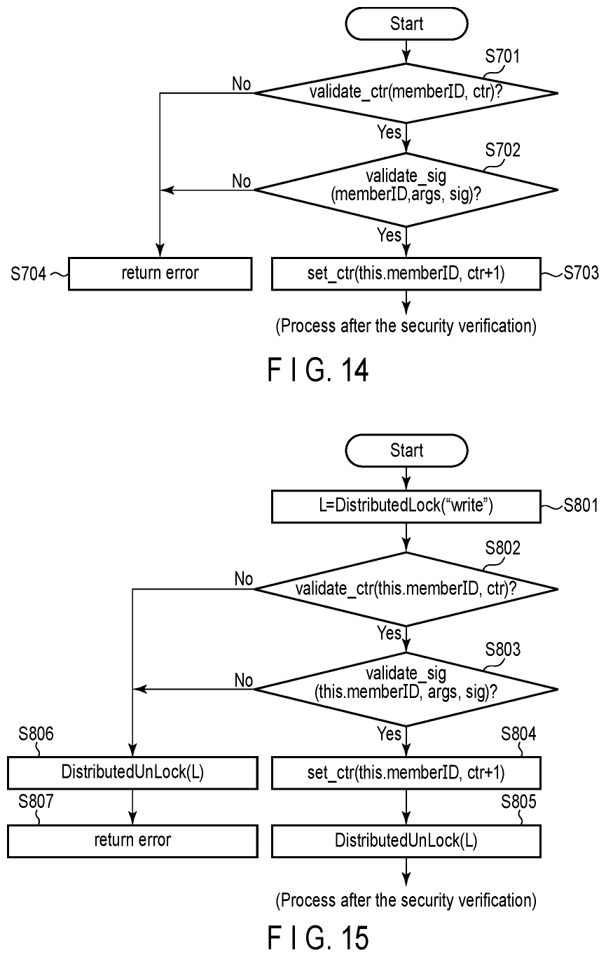

FIG. 14 illustrates a flowchart of a security verification process for the KVS operation command (set command, get command or delete command) of the shared controlled type KVS 10 when the distributed lock unit 111 is not used, according to the third embodiment. It is assumed that a structure (referred to as a context) for maintaining an attribute and a condition of each member necessary to execute the commands is assigned to the member of the KVS operation command source and that the KVS operation commands are called while accompanying the context of the call source member.

The member table 14 may be used as a storage destination of the context. A member identifier of the KVS operation command call source context is referred to as memberID.

The KVS processor 11 which has received the KVS operation command first verifies a replay counter by s validate_ctr(memberID, ctr) (S701). Validate is a command to request the verification of the replay counter. In addition, ctr is a value of ctr which the reception command includes as the input argument. The verification of the replay counter is succeeded if the ctr value is larger than or equal to the replay counter value in the member table 14 of the member corresponding to memberID or otherwise failed. If the verification of the replay counter is failed (S701: No), the KVS processor 11 returns an error (S704) and ends the process.

In contrast, if the verification of the replay counter is succeeded (S701: Yes), the KVS processor 11 verifies the signature by validate sig(memberID, args, sig) (S702). args is a list of input arguments except sig of the reception command, and sig is a value of sig which the reception command includes as the input argument. Signature calculated is executed with the public key in the member table 14 of the member corresponding to memberID for args, and the verification of the signature is succeeded if the calculated signature matches sig or failed if the calculated signature does not match sig. If the verification of the signature is failed (S702: No), the KVS processor 11 returns an error (S704: No) and ends the process.

If the verification of the signature is succeeded (S702: Yes), the KVS processor 11 updates the replay counter in the member table 14 of the member corresponding to memberID to a value (ctr+1) obtained by incrementing the value of ctr by 1 by set_ctr(memberID, ctr+1) (S703) and successively executes the process after the security verification of the received KVS operation command. set ctr is a command to request the value of the replay counter to be set to a designated value. The processes after the security verification of the KVS operation command are illustrated in the flowcharts of FIG. 3, FIG. 4, and FIG. 5 of the first embodiment.

Subsequently, FIG. 15 illustrates a flowchart of a security verification procedure for the KVS operation command (set command, get command or delete command) of the shared controlled type KVS 10 in the case of using the distributed lock unit 111, in the third embodiment. It is assumed that a structure (referred to as a context) for maintaining an attribute and a condition of each member necessary to execute the commands is assigned to the member of the KVS operation command source and that the KVS operation commands are called while accompanying the context of the call source member. The member table 14 may be used as a storage destination of the context. A member identifier of the KVS operation command call source context is referred to as memberID.

The KVS processor 11 receiving the KVS operation command or the KVS management command first waits until acquiring the distributed lock by L=DistributedLock(“write”) (S801). After that, the KVS processor 11 executes verification of the replay counter by validate_ctr(memberID, ctr) (S802). The method of verifying the replay counter is the same as the case of step S701 of FIG. 14. If the verification of the replay counter is failed (S701: No), the KVS processor 11 frees the distributed lock by DistributedUnLock(L) (S806), returns an error (S807), and ends the process.

In contrast, if the verification of the replay counter is succeeded (S802: Yes), the KVS processor 11 verifies the signature (S803). The method of verifying the replay counter is the same as the case of step S702 of FIG. 14. If the verification of the signature is failed (S803: No), the KVS processor 11 frees the distributed lock by DistributedUnLock(L) (S806), returns an error (S807), and ends the process.

If the verification of the signature is succeeded (S803: Yes), the KVS processor 11 updates the replay counter in the member table 14 of the member corresponding to memberID to a value (ctr+1) obtained by incrementing the value of ctr by 1 by set ctr(memberID, ctr+1) (S804). The KVS processor 11 frees the distributed lock by DistributedUnLock(L) (S805) and successively executes the process after the security verification of the received KVS operation command. The processes after the security verification of the KVS operation command are illustrated in the flowcharts of FIG. 9, FIG. 10, and FIG. 11 of the second embodiment.

Described above are the operations of the shared controlled type KVS 10 according to the third embodiment. Thus, the KVS operation command issued by an attacker who does not have a private key of the digital certificate issued by a predetermined certificate authority can be excluded and, furthermore, an advantage of improving the security can be achieved while achieving the same advantages as those of the first embodiment and the second embodiment.

### Fourth Embodiment

Next, a fourth embodiment will be described. The fourth embodiment relates to a tier configuration of storage for data KV.

A configuration of a shared controlled type KVS 10 according to the fourth embodiment is the same as the configuration of the shared controlled type KVS 10 of the first embodiment, the second embodiment, or the third embodiment except the configurations of the member set KV 13 and the data KV 12.

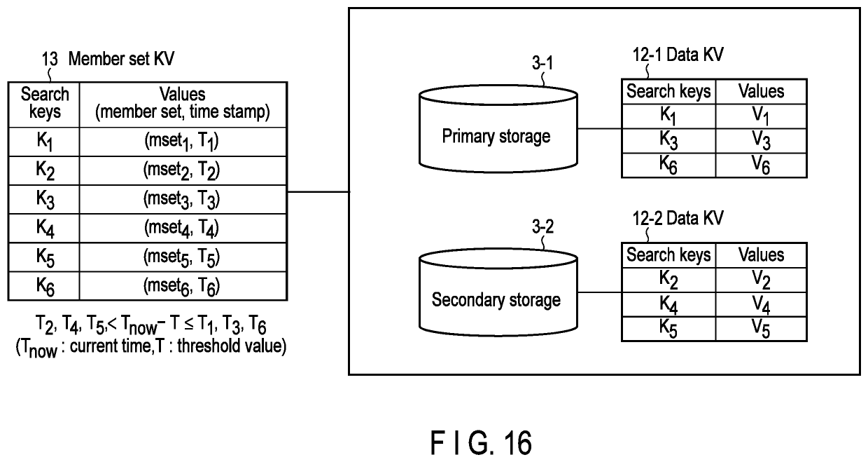

FIG. 16 illustrates an example of a configuration of the member set KV 13 and the data KV 12 (12-1, 12-2) in the fourth embodiment.

A set of (member set, time stamp) is set to the value of each entry of the member set KV 13. The member set is the same as the member set of the first embodiment, the second embodiment or the third embodiment. The time when the set command is last executed for the entry is set to the time stamp.

The data KV 12 is divided into data KV 12-1 stored in a primary storage 3-1 and data KV 12-2 stored in a secondary storage 3-2.

The KVS processor 11 executes the following data movement processes of each search key Kᵢ in the member set KV 13 regularly or at the time when the set command on the search key Kᵢ is executed.

When the time stamp Tᵢ of the entry of the member set KV 13 corresponding to the search key Kᵢ is larger than or equal to a value obtained by reducing current time T_{now} by certain time T (T_{now}−T<=Tᵢ), the KVS processor 11 uses the data KV 12-1 stored in the primary storage 3-1 for the search key Kᵢ. At this time, when the current storage destination of the data KV 12 for the search key Kᵢ is the secondary storage 3-2, the KVS processor 11 shifts the storage destination from the secondary storage 3-2 to the primary storage 3-1. In contrast, in a case where (T_{now}−T>Tᵢ), the KVS processor 11 uses the data KV-2 stored in the secondary storage 3-2 for the search key Kᵢ. At this time, when the current storage destination of the data KV 12 for the search key Kᵢ is the primary storage 3-1, the KVS processor 11 shifts the storage destination from the primary storage 3-1 to the secondary storage 3-2.

FIG. 16 illustrates a state in which the data KV 12-1 stored in the primary storage 3-1 is used as the search keys N₁, N₃, and N₆ because of (T_{now}−T<=Tᵢ) while the data KV 12-2 stored in the secondary storage 3-2 is used as the search keys K₂, K₄, and K₅ because of (T_{now}−T>Tᵢ).

Described above are the operations of the shared controlled type KVS 10 according to the fourth embodiment. Thus, as regards the data for which the set command is not executed for a long term, the update frequency of the data is assumed to be low, the data is stored in a low-cost and large-capacity storage having a low access speed, and the advantage of reducing the storage cost within a range of not deteriorating the overall process performance is thereby achieved.

Incidentally, the storage 3 in each embodiment may be a block type storage or a Key-Value type storage, and may be a solid state drive (SSD), a hard disk drive (HDD), or a storage class memory (SCM). In an NVMe SSD, in the case of block type storage, each of a Read command and a Write command of NVMe may be used as an I/O command between the KVS processor 11 of each embodiment and the external unit. In an NVMe SSD, in the case of Key-Value type storage, each of a Retrieve command and a Store command of NVMe may be used as an I/O command between the KVS processor 11 of each embodiment and the external unit.

In addition, in each embodiment, bit map, list, bloom filter with counter, or other data structure may be used as the data structure of the member set. A configuration example in a case where the data structure of the member set is one of bit map, list, and bloom filter with counter will be described below.

<In the Case of Bit Map>

Each element of the bit map is either of 1 and 0. member_set.add(memberID) executes a process of turning on the bit corresponding to the member identifier (memberID) in the bit map. member_set.delete(memberID) executes a process of turning off the bit corresponding to the member identifier (memberID) in the bit map. member_set.contains(memberID) returns a truth if the bit corresponding to the member identifier (memberID) is on, and returns a false if the bit is off. member_set.empty( ) returns a truth if all bits of the bit map are 0, and otherwise returns a false. In correspondence between the member identifier and the bit, for example, a hash value of the member identifier may be used as the bit number and, when the member table is used, a unique bit number may be assigned to each member identifier in any method and the bit number assigned to a member identifier may be stored as part of additional information of the member table entry corresponding to the member identifier.

<In the Case of List>

Each element of the list is the member identifier. member_set.add(memberID) executes a process of adding the member identifier (memberID) to the list. member_set.delete(memberID) executes a process of deleting the member identifier (memberID) in the list. member_set.contains(memberID) returns a truth if the member identifier (memberID) is included in the list, and returns a false if the member identifier is not included. member_set.empty( ) returns a truth if the number of elements included in the list is 0, and otherwise returns a false.

<In the Case of Bloom Filter with Counter>

The bloom filter with counter is a string of fixed length L_{CBF}, the starting element of the string is set as the zero-th element and each string element is a counter value. The bloom filter with counter uses k hash functions H₁, . . . , Hₖ outputting integer values of 0 or more and (L_{CBF}−1) or less. It is assumed that k hash function values of the member identifier (memberID) are i₁=H₁(memberID), . . . , iₖ=Hₖ(memberID). member_set.add(memberID) executes a process of incrementing each of the i₁-th, . . . , iₖ-th values of the string of the bloom filter with counter by 1. member_set.delete(memberID) executes a process of decrementing each of the i₁-th, . . . , iₖ-th values of the string of the bloom filter with counter by 1. member_set.contains(memberID) returns a truth if all the i₁-th, . . . , iₖ-th values of the string of the bloom filter with counter are 1 or more, and otherwise returns a false. member_set.empty( ) returns a truth if all the elements in the string of the bloom filter with counter are 0, and otherwise returns a false.

As described above, according to each of the embodiments, an operation error of the KVS use application resulting from erroneously running the get command or delete command for the KV entry for which a Certain member of the members sharing the same KVS does not issue the set command by himself, cannot be induced, the entity of the same KV entry can be shared by the members, and consequently, the storage capacity can be suppressed to 1/N (N: number of sharing members).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage; and
a controller configured to control input and output of the storage, wherein
the storage is configured to store a first table and a second table,
the first table includes a set of a search key and a value,
the second table includes a set of the search key and a member set that is a group of members issuing a set command to request the value to be stored in the first table in association with the search key, and
the controller is configured to:
when receiving the set command including a first search key and a first value in a parameter, and when the value stored in the entry of the first table corresponding to the first search key matches the first value, add the member issuing the set command to the member set stored in the entry of the second table corresponding to the first search key;
when receiving a get command that requests the value associated with a search key to be acquired from the first table wherein the search key is included as a second search key in a parameter, and when the member issuing the get command is included in the member set stored in the entry of the second table corresponding to the second search key, output the value stored in the entry of the first table corresponding to the second search key, from the first table; and
when receiving a delete command that requests the value associated with a search key to be deleted in the first table wherein the search key is included as a third search key in a parameter, delete the member issuing the delete command in the member set stored in the entry of the second table corresponding to the third search key, and delete the entry corresponding to the third search key in the first table and the entry corresponding to the third search key in the second table when number of members included in the member set becomes zero.

2. The storage device of claim 1, wherein when receiving the set command including the first search key and the first value in the parameter, and when the entry of the second table corresponding to the first search key does not exist, the controller is configured to generate the entry of the second table corresponding to the first search key, generate the entry of the first table storing the set of the first search key and the first value, and generate the entry of the second table storing a set of the first search key and the member set including the only member issuing the set command.

3. The storage device of claim 1, wherein the storage is further configured to store a third table including a set of a member identifier of the member permitted to issue the set command, the get command, and the delete command, and the member information.

4. The storage device of claim 3, wherein:
the member information includes a public key of the member permitted to issue the set command, the get command, and the delete command, and a replay counter value;
the set command, the get command, and the delete command include a counter value and a digital signature in the parameter; and
when the entry of the third table matching the member identifier of the member issuing the set command, the get command, or the delete command exists, when the counter value is larger than or equal to the replay counter value stored in the entry of the third table matching the member identifier, and when the digital signature matches a digital signature calculated with a public key stored in the entry of the third table matching the member identifier with respect to a list of parameters except the digital signature of the set command, the get command, or the delete command, the controller is further configured to execute processes corresponding to the set command, the get command, and the delete command, and update the replay counter value stored in the entry of the third table matching the member identifier to a value obtained by adding 1 to the replay counter value.

5. The storage device of claim 1, wherein:
the storage includes a primary storage and a secondary storage;
the first table includes a primary first table stored in the primary storage and a secondary first table stored in the secondary storage;
the second table stores a time at which the set command is last executed by any member included in the member set, at each entry; and
the controller is further configured to store in the primary first table an entry of the first table corresponding to the entry of the second table where a time larger than or equal to a value obtained by subtracting a certain value from a current value is stored, and store in the secondary first table an entry of the first table corresponding to the entry of the second table where a time smaller than a value obtained by subtracting a certain value from the current value is stored.

6. The storage device of claim 5, wherein when receiving the set command including the first search key and the first value in the parameter, and when the entry of the first table corresponding to the first search key is stored in the secondary first table, the controller is further configured to shift the entry of the first table corresponding to the first search key from the secondary first table to the primary first table.

7. The storage device of claim 1, further comprising a network interface configured to access the storage via a network,
wherein the controller is provided in the network interface.

8. A storage client device connected to an external storage via a network, the external storage storing a first table and a second table, the first table storing a set of a search key and a value, the second table storing a set of the search key and a member set that is a group of members issuing a set command to request the value to be stored in the first table in association with the search key, the storage client device comprising
a controller configured to execute a process relating to the external storage connected via the network and corresponding to the set command, a process corresponding to the get command to request the value associated with a search key to be acquired from the first table, and a process corresponding to the delete command to request the value associated with a search key to be deleted in the first table,
wherein the controller is configured to:
when receiving the set command including a first search key and a first value in a parameter, and when the value stored in the entry of the first table corresponding to the first search key matches the first value, add the member issuing the set command to the member set stored in the entry of the second table corresponding to the first search key;
when receiving the get command including a second search key in the parameter, and when the member issuing the get command is included in the member set stored in the entry of the second table corresponding to the second search key, output the value stored in the entry of the first table corresponding to the second search key, from the first table; and
when receiving the delete command including a third search key in the parameter, delete the member issuing the delete command in the member set stored in the entry of the second table corresponding to the third search key, and delete the entry corresponding to the third search key in the first table and the entry corresponding to the third search key in the second table when number of members included in the member set becomes zero.

9. The storage client device of claim 8, wherein when receiving the set command including the first search key and the first value in the parameter, and when the entry of the second table corresponding to the first search key does not exist, the controller is configured to generate the entry of the second table corresponding to the first search key, generate the entry of the first table storing the set of the first search key and the first value, and generate the entry of the second table storing a set of the first search key and the member set including the only member issuing the set command.

10. The storage client device of claim 8, wherein the controller comprises a distributed lock unit configured to execute exclusive control on issuing the set command, the get command, or the delete command between the controller and the controller of other storage client device.

11. A control method of a storage device that stores a first table and a second table, the first table including a set of a search key and a value, the second table including a set of the search key and a member set that is a group of members issuing a set command to request the value to be stored in the first table in association with the search key, the control method comprising:
when receiving the set command including a first search key and a first value in a parameter, and when the value stored in the entry of the first table corresponding to the first search key matches the first value, adding the member issuing the set command to the member set stored in the entry of the second table corresponding to the first search key;
when receiving a get command that requests the value associated with a search key to be acquired from the first table wherein the search key is included as a second search key in a parameter, and when the member issuing the get command is included in the member set stored in the entry of the second table corresponding to the second search key, outputting the value stored in the entry of the first table corresponding to the second search key, from the first table; and
when receiving a delete command that requests the value associated with a search key to be deleted in the first table wherein the search key is included as a third search key in a parameter, deleting the member issuing the delete command in the member set stored in the entry of the second table corresponding to the third search key, and deleting the entry corresponding to the third search key in the first table and the entry corresponding to the third search key in the second table when number of members included in the member set becomes zero.

12. The control method of claim 11, further comprising
when receiving the set command including the first search key and the first value in the parameter, and when the entry of the second table corresponding to the first search key does not exist, generating the entry of the second table corresponding to the first search key, generating the entry of the first table storing the set of the first search key and the first value, and generating the entry of the second table storing a set of the first search key and the member set including the only member issuing the set command.

13. The control method of claim 12, wherein:
the storage device further stores a third table including a set of a member identifier of the member permitted to issue the set command, the get command, and the delete command, and the member information;
the member information includes a public key of the member permitted to issue the set command, the get command, and the delete command, and a replay counter value;
the set command, the get command, and the delete command include a counter value and a digital signature in the parameter; and
the control method further comprises:
when the entry of the third table matching the member identifier of the member issuing the set command, the get command, or the delete command exists, when the counter value is larger than or equal to the replay counter value stored in the entry of the third table matching the member identifier, and when the digital signature matches a digital signature calculated with a public key stored in the entry of the third table matching the member identifier with respect to a list of parameters except the digital signature of the set command, the get command, or the delete command more, executing processes corresponding to the set command, the get command, and the delete command, and updating the replay counter value stored in the entry of the third table matching the member identifier to a value obtained by adding 1 to the replay counter value.

14. The control method of claim 11, wherein:
the storage device includes a primary storage and a secondary storage;
the first table includes a primary first table stored in the primary storage and a secondary first table stored in the secondary storage;
the second table stores a time at which the set command is last executed by any member included in the group of the members, at each entry; and
the control method further comprises storing in the primary first table an entry of the first table corresponding to the entry of the second table where a time larger than or equal to a value obtained by subtracting a certain value from a current value is stored, and storing in the secondary first table an entry of the first table corresponding to the entry of the second table where a time smaller than a value obtained by subtracting a certain value from the current value is stored.

15. The control method of claim 14, further comprising
when receiving the set command including the first search key and the first value in the parameter, and when the entry of the first table corresponding to the first search key is stored in the secondary first table, shifting the entry of the first table corresponding to the first search key from the secondary first table to the primary first table.
